(19) United States
(12) Patent Application Publication
(10) Pub. No.: US 2012/0167308 A1
(43) Pub. Date: Jul. 5, 2012

(54) Composite Gel and Foam Support Pad and Method for Manufacturing Same

(76) Inventor: James Van Lear, Shady Shores, TX (US)

(21) Appl. No.: 13/328,457

(22) Filed: Dec. 16, 2011

Related U.S. Application Data
(60) Provisional application No. 61/460,249, filed on Dec. 29, 2010.

(51) Int. Cl. A47C 20/00; B29C 39/18; A47C 16/00

(52) U.S. Cl. 5/655.5; 5/655.9; 156/242

(57) ABSTRACT

The disclosure and claims herein are directed to a composite support pad comprising a foam base portion with a top surface, an opposing bottom surface substantially parallel to the top surface, and a plurality of receptacles in the foam base portion, and a top portion comprising a top layer on the top surface with a plurality of columns extending from the top layer into the receptacles. The disclosure and claims herein are also directed to a method for producing a composite support pad, the method comprising the steps of providing a foam base portion with a top surface, an opposing bottom surface substantially parallel to the top surface, and a plurality of receptacles in the foam base portion, applying a composition to the foam base portion, and curing the composition, wherein the curing adheres the top layer to the top surface and the columns to the receptacles.

### CROSS-REFERENCE TO RELATED APPLICATIONS

This application is based on and claims priority to U.S. Provisional Application Ser. No. 61/460,249, filed on Dec. 29, 2010, which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

This invention relates to a composite gel and foam product for use in mattresses, cushions, seats, pads, and other types of supportive items. The invention also relates to a method for manufacturing such a product without requiring the use of a traditional metal mold.

2. Description of Related Art

Healthcare and household mattresses, as well as seat cushions, pads, and other varieties of cushioned supports have increasingly utilized gel to achieve desired levels of comfort and support. Some known products have integrated such gel with a supportive foam of the type conventionally employed in mattresses and other products for supporting humans and pets.

Known methods for manufacturing supports employing both gel and foam exhibit a variety of shortcomings. Typically, the gel must first be extruded, injected, or poured into and shaped by large and expensive metal molds. These molds are usually large and quite heavy. As a result, they are difficult to maneuver into position and properly secure during the molding operation. Extracting the cooled and formed gel from the mold can also be difficult and time consuming. Moreover, the size of the molded gel support is strictly limited by the size of the available metal mold.

After the gel is molded, further problems are encountered securing the gel to one or more layers of foam. Cured gel is unable to adhere directly to the foam. As a result, the gel usually must first be heat bonded to a thin textile layer of scrim. This requires the purchase and maintenance of additional manufacturing material which results in additional manufacturing steps and resultant expenses.

Conventional gel support products also tend to be vertically unstable and are apt to buckle outwardly when a large load is applied. This is undesirable and can significantly reduce the usefulness, support, and lifespan of the product.

### BRIEF SUMMARY OF THE INVENTION

The disclosure and claims herein are directed to a composite support pad comprising a foam base portion with a top surface, an opposing bottom surface substantially parallel to the top surface, and a plurality of receptacles extending from the top surface towards the bottom surface, and a top portion comprising a top layer on the top surface with a plurality of columns extending from the top layer into the receptacles.

The disclosure and claims herein are also directed to a method for producing a composite support pad, the method comprising the steps of providing a foam base portion with a top surface, an opposing bottom surface substantially parallel to the top surface, and a plurality of receptacles extending from the top surface towards the bottom surface, applying a composition to the foam base portion that forms columns of the composition in the receptacles of the foam base portion and forms a top layer on the top surface, and curing the composition wherein the curing adheres the top layer to the top surface and the columns to the receptacles.

In one exemplary embodiment the foam base portion is comprised of polyurethane, viscoelastic, or latex foam, but the foam base portion can be any type of foam known in the art. In another exemplary embodiment, the foam base portion is comprised of a plurality of layers of foam materials. In one exemplary embodiment the top portion is comprised of a gel material. In another exemplary embodiment the gel material is an elastomeric non-soy gel but could be any type of gel known in the art. In another exemplary embodiment at least one of the plurality of receptacles extends through the entire foam base portion between the top and bottom surfaces. In another exemplary embodiment the plurality of receptacles extend from the top surface to a distance from about 10% to about 100% of the distance between the top and bottom surfaces. In an exemplary embodiment the top layer substantially covers the top surface. In another exemplary embodiment the plurality of receptacles are substantially round. In yet another embodiment the plurality of receptacles are arranged in substantially aligned rows in a matrix configuration. In another exemplary embodiment the top layer and the plurality of columns are integral. In one exemplary embodiment the plurality of columns are substantially perpendicular to the top and bottom surfaces.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a top perspective view of the composite support pad in accordance with an exemplary embodiment of the present invention.

FIG. 2 is a bottom perspective view of the composite support pad of FIG. 1.

FIG. 3 is a cross section view of the composite support pad of FIG. 1 along line 3.

FIG. 4 is a perspective view of a continuous roll of foam base portion.

FIG. 5 is a perspective view of a rectangular foam base portion.

FIG. 6 is a fragmentary perspective view of a section of the foam base portion of FIG. 5 with a transverse receptacle formed therethrough between the top and bottom surfaces of the foam base portion.

FIG. 7 is a perspective, schematic view showing the application of gel to a foam base portion.

FIG. 8 depicts a block diagram of a method for manufacturing a composite support pad in accordance with an exemplary embodiment of the present invention.

FIG. 9 depicts an exemplary embodiment of step 102 of the method of FIG. 8.

FIG. 10 depicts a first alternative exemplary embodiment of step 102 of the method of FIG. 8.

FIG. 11 depicts an exemplary embodiment of steps 104 and 106 of the method of FIG. 8.

FIG. 12 depicts a block diagram of a first alternative exemplary embodiment of a method for manufacturing a composite support pad.

FIG. 13 depicts a block diagram of a second alternative exemplary embodiment of a method for manufacturing a composite support pad.

### DETAILED DESCRIPTION OF PREFERRED EMBODIMENT

The disclosure and claims herein are directed to a composite support pad comprising a foam base portion with a top surface, an opposing bottom surface substantially parallel to the top surface, and a plurality of receptacles extending from the top surface towards the bottom surface, and a top portion comprising a top layer on the top surface with a plurality of columns extending from the top layer into the receptacles.

The disclosure and claims herein are also directed to a method for producing a composite support pad, the method comprising the steps of providing a foam base portion with a top surface, an opposing bottom surface substantially parallel to the top surface, and a plurality of receptacles extending from the top surface towards the bottom surface, applying a composition to the foam base portion that forms columns of the composition in the receptacles of the foam base portion and forms a top layer on the top surface, and curing the composition wherein the curing adheres the top layer to the top surface and the columns to the receptacles.

The composite support pad as described in the disclosure and claims herein is described generally and may be employed in virtually any and all applications and industries including but not limited to healthcare, bedding, furniture, exercise, physical therapy, sound insulation, transportation, etc. The specific embodiments of the composite support pad discussed herein do not constitute a limitation of the disclosure and claims.

The composite support pad and manufacturing the composite support pad as described herein provide a number of benefits. The foam base portion itself acts as the mold for the gel. The cost and complexity of utilizing a conventional metal mold is thereby eliminated. The need for tooling a metal mold is also eliminated. The composite support is not limited in size and configuration by available mold length limitations. Significantly, the considerable effort normally required to remove the gel from the mold is no longer needed. Additionally, no additional materials or steps are needed to adhere the gel to the foam. The molded gel is bonded to and ready for virtually immediate use with the foam comprising the mold.

Additionally, the composite support pad as described herein achieves improved effective support and comfort. The receptacles may be formed in the foam base portion in different number, size, depth, and layout in order to achieve various comfort and support levels and characteristics.

When foam and gel are bonded in accordance with this invention, the foam base portion improves the performance of the gel, and vice versa, in a manner not previously achieved. In particular, the foam effectively surrounds the gel columns so that the stability and performance of the gel is improved. The gel is vertically stable and is much less apt to buckle in an outward direction when a load is applied to a surface of the composite support pad. The gel also helps to effectively reinforce the foam. When the gel is bonded directly to the foam in the manner disclosed herein, the foam, and particularly soft foam, is not liable to bottom out under a heavy load. The gel provides for much greater stability and support.

The manufacturing process described herein also represents a significant improvement over conventional techniques for manufacturing gel and foam support cushions because adhesive interconnection is not required between the foam and gel components. Rather, the gel is poured directly onto the foam base portion and into the receptacles in the foam base portion. This allows the gel to effectively bond directly to the foam as the gel cures. This eliminates the need to use scrim and adhesives in order to bond the foam to the gel. Considerable time and expense are thereby saved. Moreover, an improved, more stable and comfortable gel and foam composite support pad is achieved. Nonetheless, it should be understood that scrim may still be applied to the composite above the gel component for use in different applications.

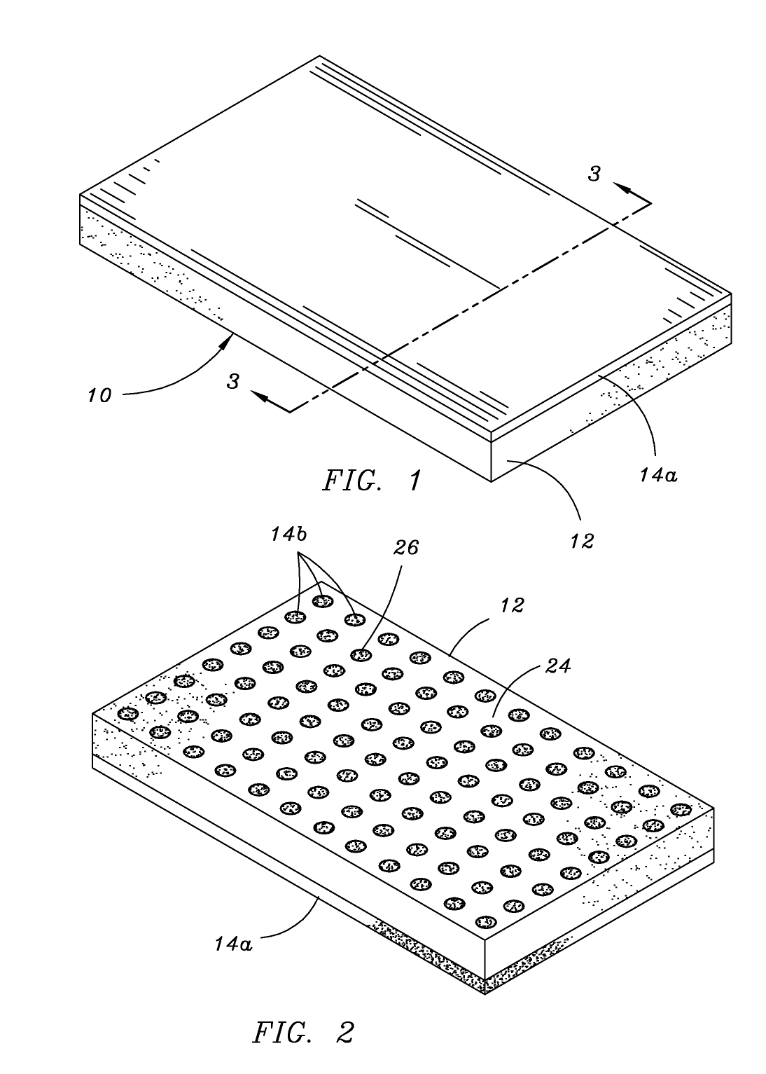

Referring to FIGS. 1 and 2, composite support pad 10 comprises a composite of foam base portion 12 and composition 14 that are bonded together in accordance with the manufacturing process disclosed herein. Composition 14 includes a top layer 14a and columns 14b. Although a gel is discussed herein as an exemplary embodiment of the composition, the disclosure and claims extend to any composition. As is described more fully below, composite support pad 10 may have assorted overall shapes, sizes, and thicknesses.

As used herein, the term “foam” encompasses, but is not limited to, solid porous foams, reticulated foams, water-disintegratable foams, open-cell foams, closed-cell foams, foamed synthetic resins, cellulosic foams, natural foams, polyurethane foams, viscoelastic (“visco”) foams, and latex foams. In one embodiment the foam used for foam base portion 12 has an Indentation Force Deflection (IFD) of from about 3 to about 70.

As used herein, the term “gel” encompasses, but is not limited to, a viscoelastic or semi-solid, jelly-like state assumed by a colloidal dispersion or a substantially dilute cross-linked system. The term “gel” encompasses a three-dimensional polymeric structure that itself is insoluble in a particular liquid but which is capable of absorbing and retaining large quantities of the liquid to form a stable, often soft and pliable, but to one degree or another a shape-retentive structure. When the liquid is water, the gel is typically referred to as a hydrogel. The gel may also contain additives that affect the properties of the gel. Examples of suitable additive that increase the energy (i.e., heat) absorbing properties of the gel include boron, talc, quartz, aluminum sulfate, diamond dust, etc.

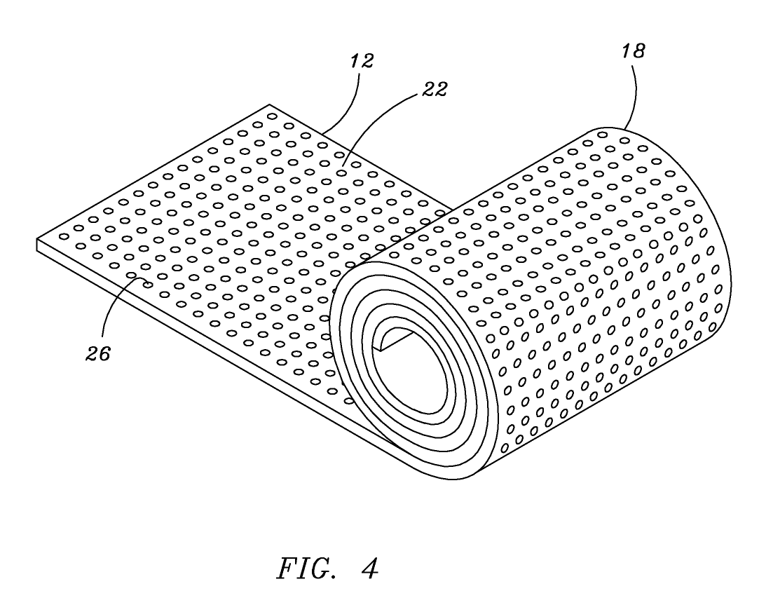

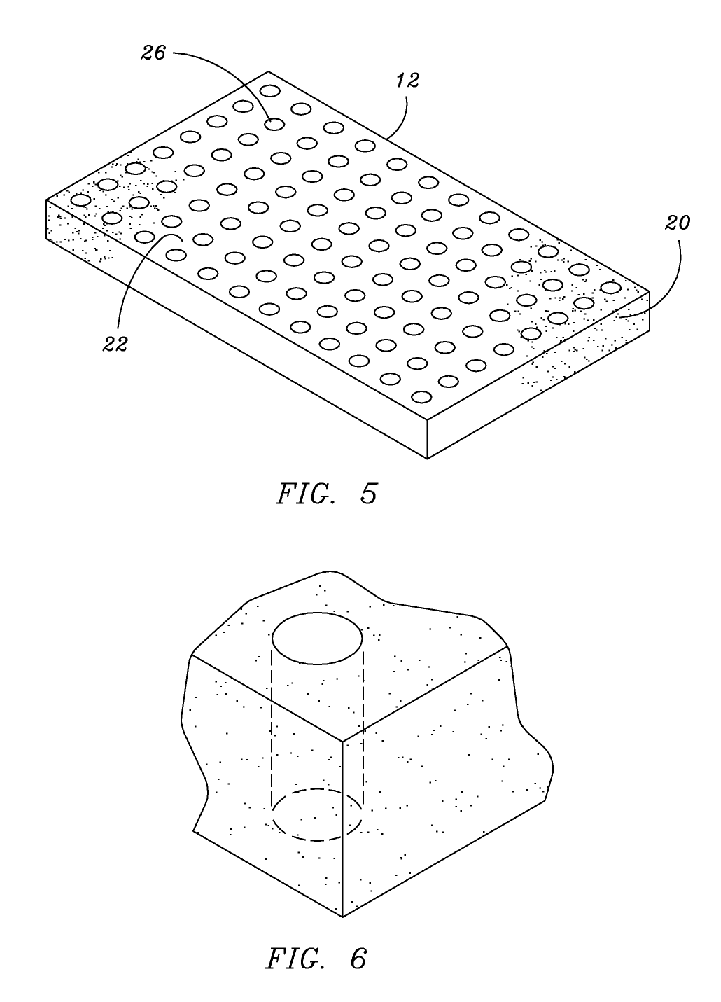

Foam base portion 12 may be available in a roll, such as roll 18 shown in FIG. 4. A desired length can be cut from roll 18, or roll 18 can be processed as a whole. Alternatively, foam base portion 12 may be provided in the form of a rectangular or otherwise configured planar sheet, such as sheet 20 shown in FIG. 5. Typically, foam base portion 12 is rolled when the foam is relatively thin (e.g., less than about 2 inches thick). When thicker foam is required, sheets 20 of foam base portion 12 are employed. However, the disclosure also extends to cutting a sheet 20 from roll 18. The thickness of the foam may vary in accordance with the intended application and expected load. In one embodiment the foam has a preferred thickness range of about 0.1 inches to about 10 inches. In another embodiment, the foam has a preferred thickness range of about 0.5 inches to about 2.5 inches. The preferred thickness of the foam can change depending on the end application and the type of gel used.

Although the disclosure and claims herein are not limited to a specific width of foam, foam base portion 12 preferably has a width from about 12 inches to about 90 inches. This allows foam base portion 12 to be continuously fed or pushed by a pusher machine, feeder machine, or conveyor known in the art so that the gel may be applied thereto as described below. In order to obtain a piece of foam base portion 12 having a selected length for use in support 10, the desired length of foam from roll 18 (shown in FIG. 4), or sheet 20 (shown in FIG. 5), is simply transversely cut and removed from the remaining foam supply using a conventional cutting machine. Alternatively, the entire roll 18 or sheet 20 may have gel 14 applied before cutting into selected lengths.

As shown in FIGS. 2, 3, and 5, foam base portion 12 includes a top surface 22 and a bottom surface 24 substantially parallel to top surface 22. Foam base portion 12 includes a plurality of receptacles 26 formed in top surface 22 to extend transversely through the thickness of foam base portion 12 between top and bottom surfaces 22 and 24. In one embodiment, receptacles 26 are arranged in substantially aligned rows in a matrix configuration. In another embodiment, receptacles 26 are arranged in a concentric circular configuration. In still another embodiment, receptacles 26 are arranged in a number of zones, stars, octagons, squares, or a combination of shapes or layouts. The disclosure and claims herein extend to any configuration of receptacles 26 in foam base portion 12.

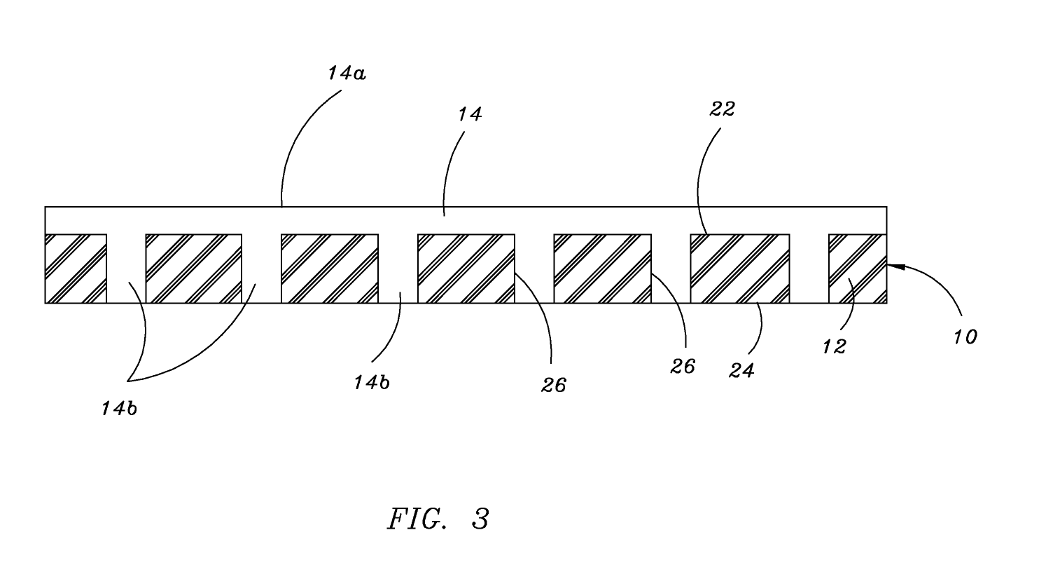

In one exemplary embodiment, receptacles 26 are formed completely through foam base portion 12 from top surface 22 to bottom surface 24, as depicted in FIGS. 3 and 6. In another exemplary embodiment, recesses 26 extend to a depth between top and bottom surfaces 22 and 24 of foam base portion 12. In one exemplary embodiment, receptacles 22 are substantially perpendicular to top and bottom surfaces 22 and 24. In this embodiment, the depth of receptacles 26 is from about 1% to about 100% of the distance between top and bottom surfaces 22 and 24 (i.e., the thickness of foam base portion 12). In another embodiment, receptacles 26 are angled between top surface 22 and bottom surface 24. In this embodiment, the depth of receptacles 26 is from about 1% to about 300% of the distance between top and bottom surfaces 22 and 24 depending on the angle of receptacles 26. Receptacles 26 could also be comprised of a portion of receptacles substantially perpendicular to top and bottom surfaces 22 and 24 and a portion of receptacles angled between top surface 22 and bottom surface 24.

In one embodiment, receptacles 26 have cylindrical shapes with circular cross sections. In another embodiment, receptacles 26 may have square, rectangle, oval, star, or any other shape with any shaped cross section. In yet another embodiment, receptacles 26 could be comprised of receptacles of many different shapes with many different shaped cross sections. Receptacles 26 may be molded or manufactured directly into foam base portion 12. Alternatively, foam base portion 12 may be manufactured without receptacles 26 and receptacles 26 can be added to foam base portion 12. Receptacles 26 can be added by cutting, punching, drilling, burning, or any method for creating receptacles 26 in foam base portion 12.

One non-limiting example of foam base portion 12 is now described to show an example embodiment. Foam base portion 12 is comprised of a latex foam. Foam base portion 12 is about 2 inches thick (i.e., the distance between top surface 22 and bottom surface 24 is about 2 inches). Foam base portion 12 has receptacles 26 that are substantially perpendicular to top surface 22 and bottom surface 24. Receptacles 26 are cylindrically shaped with circular cross sections and are formed completely through foam base portion 12 from top surface 22 to bottom surface 24. Receptacles 26 are arranged in substantially aligned rows in a matrix configuration. Receptacles 26 are about one inch apart and have a diameter of about ¼ of an inch.

While the above example shows one exemplary embodiment, the foam base material and thickness, and the receptacles' shape, orientation, layout, density, depth, and size can change based upon the application where composite support pad 10 will be employed and the type of foam and gel used. For example, a greater concentration of receptacles provides more support than fewer receptacles in the same type of foam because of the larger concentration of gel in the foam. The attributes of the foam and receptacles is also influenced by the type of gel used. For example, the hardness of the gel can be increased causing more support than a softer gel in the same type of foam. Thus, a composite support pad can be comprised of softer foam with more receptacles and/or harder gel and have the same supportive qualities as a composite support pad comprised of harder foam with fewer receptacles and/or softer gel.

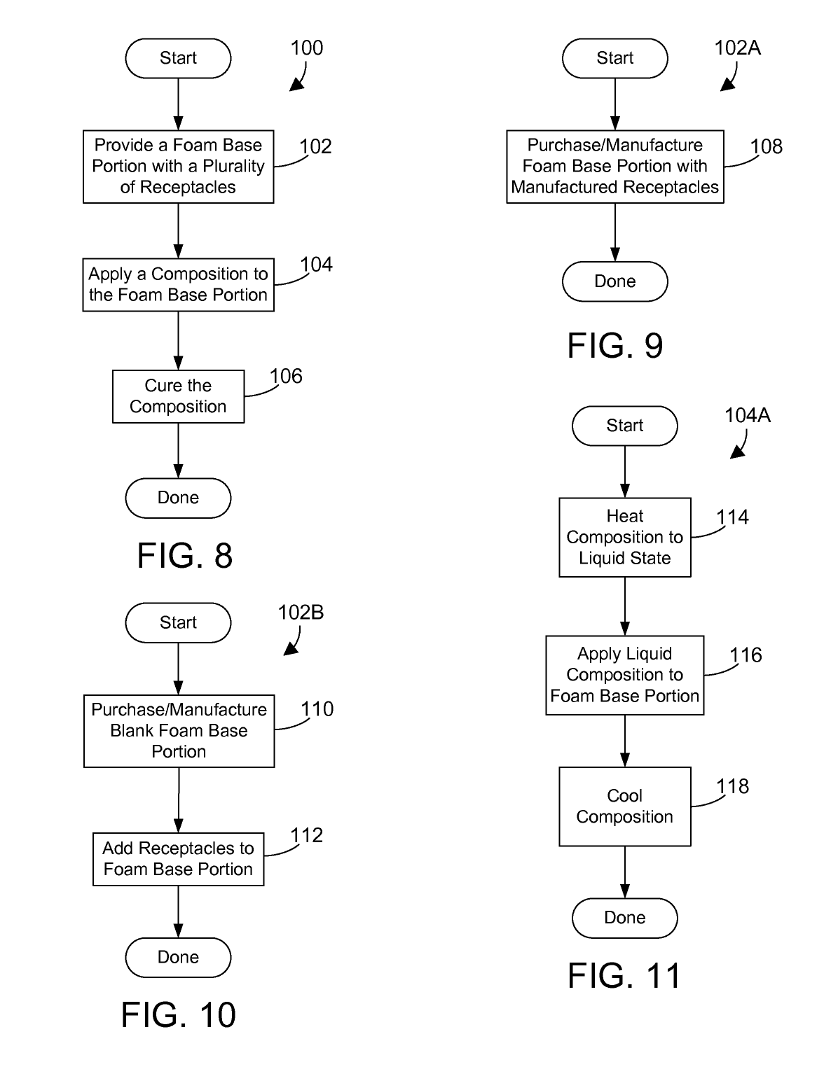

Referring to FIG. 8, a method 100 for producing composite support pad 10 begins by providing a foam base portion with a plurality of receptacles (step 102). A composition is then applied to the foam base portion (step 104). The composition is cured (step 106), and method 100 is complete. In one exemplary embodiment, curing happens as the composition cools. Alternatively, other variations of thermal, photosensitive, or chemically reactive compositions may be utilized. Step 106 extends to any method of curing the composition applied in step 104.

Referring to FIG. 9, a method 102A shows an exemplary embodiment of step 102 in FIG. 8. A foam base portion that already includes receptacles is purchased or manufactured (step 108), and method 102A is complete.

Referring to FIG. 10, a method 102B shows a first alternative embodiment of step 102 in FIG. 8. A blank foam base portion (i.e., without manufactured receptacles) is purchased or manufactured (step 110). Receptacles are then added to the foam base portion (step 112), and method 102B is complete. Receptacles can be added by cutting, punching, drilling, burning, or any method for creating receptacles known in the art. Note that while adding receptacles is described herein regarding a blank foam base portion, receptacles may also be added to a foam base portion that had receptacles manufactured into the foam base portion.

Referring to FIG. 11, a method 104A shows an exemplary embodiment of steps 104 and 106 in FIG. 8, and begins by heating the composition to a liquid state (step 114). The liquid composition is then applied to the base portion (step 116). The composition is then cooled (step 118), and method 104A is complete.

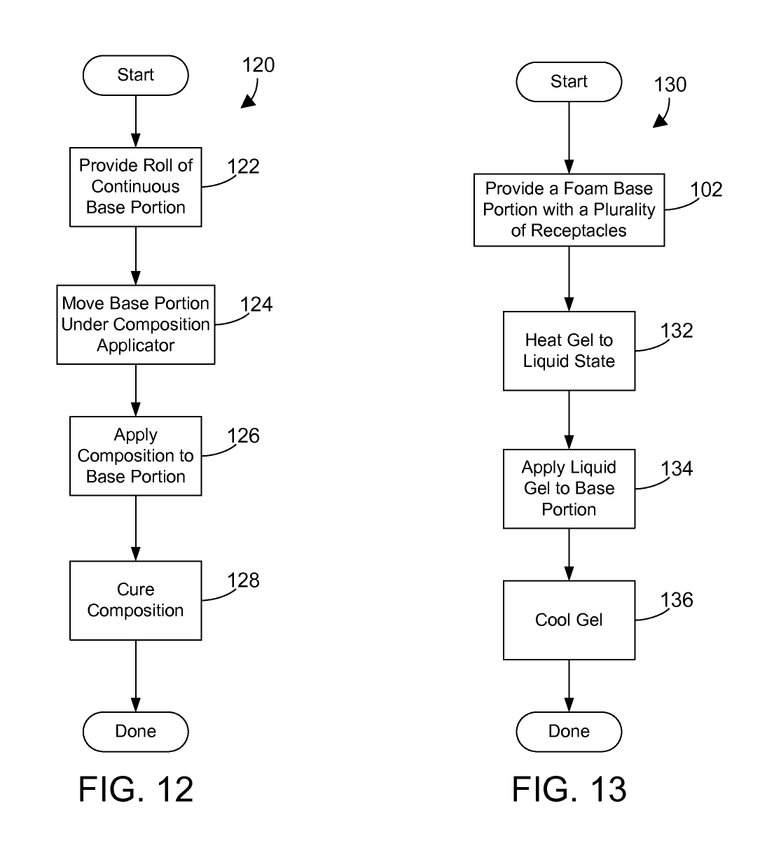

Referring to FIG. 12, a method 120 for producing a composite support pad in accordance with a first alternative exemplary embodiment begins by providing a roll of a continuous base portion (step 122). The base portion is then moved under a composition applicator (step 124). The composition applicator then applies the composition to the base portion (step 126). The composition is cured (step 128), and method 122 is complete.

Referring to FIG. 13, a method 130 for producing a composite support pad in accordance with a second alternative exemplary embodiment begins by providing a foam base portion with a plurality of receptacles (step 102). Gel is heated to a liquid state (step 132). The liquid gel is then applied to the foam base portion (step 134). The gel is cooled (step 136), and method 130 is complete.

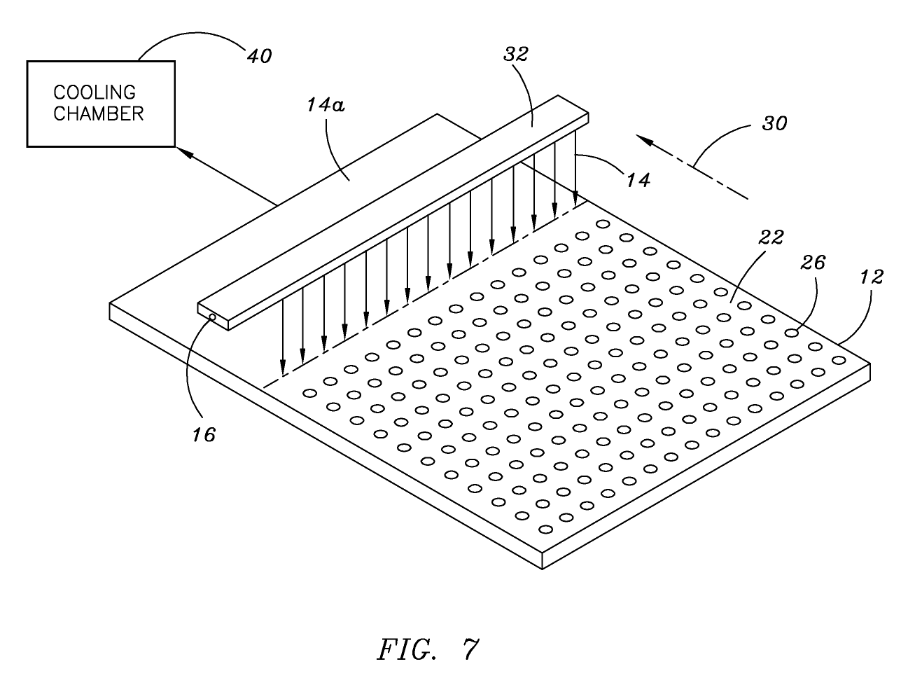

A simple non-limiting example is now shown to illustrate the methods described above. As shown in FIG. 7, foam base portion 12 is fed by an appropriate feeder, pusher, or conveyer mechanism (not shown) in the direction indicated by arrow 30 beneath a liquid gel applicator head 32 (step 102 in FIG. 13). Gel 14 is heated to a liquid state (step 132 in FIG. 13). In one exemplary embodiment gel 14 is heated to a temperature of from about 225° F. to about 400° F. Liquid gel 14 is then pumped or otherwise delivered in liquid form to applicator head 32 via input port 16. Applicator head 32 is operable to apply gel 14 to top surface 22 of foam base portion 12 (step 134 in FIG. 13). As the foam base portion moves beneath applicator head 32, the heated liquid gel 14 enters and fills each of the receptacles 26 in foam base portion 12 and forms gel columns 14b throughout foam base portion 12 (as shown in FIGS. 2 and 3). Heated liquid gel 14 also forms a top layer 14a of gel 14 on top surface 22 (as shown in FIGS. 1 and 3). In one embodiment top layer 14a has a thickness that can range from about 0.0625 inches to about 4 inches. However, the disclosure and claims herein extend to any thickness of top layer 14a. In a first exemplary embodiment, gel 14 is kept on top of foam base portion 12 by guides on the side or top of foam base portion 12. These guides can be integral to applicator head 32, part of the conveyor, removable pieces, attachments to the foam base portion 12, or any type of guide that keeps gel 14 on top of foam base portion 12. In a second exemplary embodiment, the amount of gel 14 that is allowed to flow on top of foam base portion 12 is regulated such that the gel flows into an even layer over the top of foam base portion 12. In a third exemplary embodiment, the amount of gel 14 that is allowed to flow on top of foam base portion 12 is regulated such that the gel does not flow over the sides of foam base portion 12 and leaves an uneven layer of gel 14 on top of foam base portion 12. The uneven layer of gel 14 can be left on the composite support pad 10 to provide for different support on the same composite support pad, or the parts of the composite support pad that do not have at least a threshold thickness of top layer 14a can be removed from composite support 10 and discarded. In a fourth exemplary embodiment, gel 14 is allowed to flow over the side of foam base portion 12. The disclosure and claims herein extend to any way to keep gel 14 on top of foam base portion 12.

After the foam base portion 12 has passed beneath applicator 32 and heated liquid gel 14 has been applied to the foam base portion, the composite support pad 10 is delivered to a cooling chamber 40. Foam base portion 12 can be transported to cooling chamber 40 after the entire portion has received gel 14. Alternatively, foam base portion 12 can be transported by the feeder, pusher, or conveyer mechanism through cooling chamber 40. In one exemplary embodiment, cooling chamber 40 entirely encompasses composite support pad 10. In an alternative exemplary embodiment, composite support pad 10 passes through cooling chamber 40. Cooling chamber 40 cools gel 14 (i.e., top layer 14a and columns 14b) so that it does not burn foam base portion 12 (step 136 in FIG. 13).

In one exemplary embodiment, cooling chamber 40 causes air (refrigerated or room temperature) to be forced onto sides of composite support pad 10. In an alternative exemplary embodiment, cooling chamber 40 comprises a pressurized water cooling system that comprises at least one radiator in proximity to at least one side of composite support pad 10 and forces water to the radiator. The disclosure and claims extend to any way to cool or cure gel 14. Additional substances may be added to the gel to help the gel cure more quickly or change the properties of the gel. For example, a mixture of about 50% talc or baby powder and about 50% baking soda that is added to the gel after the gel is applied to the foam helps the gel cure more quickly and improves the gel (e.g., better smelling and softer to the touch).

As the gel cools, it cures and bonds to the foam to produce composite piece 10 as shown in FIGS. 1 and 2. In particular, the gel that fills receptacles 26 in foam base portion 12 forms respective gel columns 14b that are unitarily attached to and project from top layer 14a formed over the top surface 22 of foam base portion 12. Gel 14 cures and bonds to the foam as it is cooled. A composite piece 10 is thereby produced wherein the foam base portion 12 bonds to both top layer 14a and the gel columns 14b that project from top layer 14a and extend through respective receptacles 26.

It is important to note that in each embodiment disclosed herein, a metal form is not needed for the composition or gel. Foam base portion 12 acts as a form for gel 14 as gel 14 is applied to foam base portion 12. Foam base portion 12 effectively serves as the mold for receiving the gel and for supporting the gel while it cures and bonds to the foam. This eliminates the need to use bulky, expensive, and difficult to operate metal molds, as are traditionally used to shape the gel.

In alternative embodiments other forms of gel and alternative means for curing and hardening the gel may be utilized. For example, thermal, photosensitive, or chemically reactive gels may be deposited in liquid or powdered form onto the foam mold. In some embodiments chemicals may be added to the gel to induce curing. Ultraviolet radiation can be employed to cure and harden photosensitive gels. In these embodiments, cooling chamber 40 would instead be a curing chamber where the gel would be cured by the means required to cure the type of gel applied.

Composite support pad 10 may be utilized in accordance with conventional and well known manufacturing techniques. For example, desired lengths of foam or completed gel and foam composite may be cut transversely as desired utilizing conventional cutting equipment. Likewise, the completed composite support pad 10 can be trimmed, shaped and sized as needed, for particular applications. After manufacture of the composite support pad is finished, the composite support pad may be installed and used in various products such as mattresses, cushions, pads and other means of support.

Although specific features of the invention are shown in some of the drawings and not others, this is for convenience only, as each feature may be combined with any and all of the other features in accordance with this invention. Since many possible embodiments may be made of the disclosure without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A composite support pad comprising:
a foam base portion comprising a top surface, an opposing bottom surface substantially parallel to said top surface, and a plurality of receptacles extending from said top surface towards said bottom surface; and
a top portion comprising a top layer adjacent said top surface and a plurality of columns extending from said top layer into said receptacles.

2. The composite support pad of claim 1 wherein said foam base portion comprises a polyurethane, viscoelastic, or latex foam.

3. The composite support pad of claim 1 wherein said foam base portion comprises a plurality of layers of foam materials.

4. The composite support pad of claim 1 wherein said top portion comprises a gel material.

5. The composite support pad of claim 4 wherein said gel material comprises an elastomeric non-soy gel.

6. The composite support pad of claim 1 wherein at least one of said plurality of receptacles extends through the entire foam base portion between said top and bottom surfaces.

7. The composite support pad of claim 1 wherein the plurality of receptacles extend from said top surface to a distance from about 10% to about 100% of the distance between said top and bottom surfaces.

8. The composite support pad of claim 1 wherein said top layer substantially covers said top surface.

9. The composite support pad of claim 1 wherein said plurality of receptacles are substantially round.

10. The composite support pad of claim 1 wherein said plurality of receptacles are arranged in substantially aligned rows in a matrix configuration.

11. The composite support pad of claim 1 wherein said top layer and said plurality of columns are integral.

12. The composite support pad of claim 1 wherein said plurality of columns are substantially perpendicular to said top and bottom surfaces.

13. A method for producing a composite support pad, the method comprising the steps of:
(A) providing a foam base portion comprising a top surface, an opposing bottom surface substantially parallel to said top surface, and a plurality of receptacles extending from said top surface towards said bottom surface;
(B) applying a composition to said foam base portion that forms columns of said composition in said receptacles of said foam base portion and forms a top layer adjacent said top surface; and
(C) curing said composition.

14. The method of claim 13 wherein said foam base portion comprises polyurethane, viscoelastic, or latex foam.

15. The method of claim 13 wherein said foam base portion comprises a plurality of layers of foam materials.

16. The method of claim 13 wherein said composition comprises a gel material.

17. The method of claim 16 wherein said gel material comprises an elastomeric non-soy gel.

18. The method of claim 13 wherein said plurality of receptacles extends through the entire base portion between said top and bottom surfaces.

19. The method of claim 13 wherein said plurality of receptacles extend from said top surface to a distance from about 10% to about 100% of the distance between said top and bottom surfaces.

20. The method of claim 13 wherein said top layer substantially covers said top surface.

21. The method of claim 13 wherein said composition is applied in a liquid form.

22. The method of claim 13 wherein step (B) comprises the steps of:
heating said composition to a liquid state; and
applying said liquid composition to said foam base portion such that said liquid composition flows into said plurality of receptacles.

23. The method of claim 22 wherein step (C) comprises the step of cooling said composition thereby forming said columns of said composition in said plurality of receptacles of said base portion and forming said top layer adjacent said top surface, wherein said cooling adheres said top layer to said top surface and said columns to said receptacles.

24. The method of claim 13 wherein said plurality of receptacles are substantially round.

25. The method of claim 13 wherein said plurality of receptacles are arranged in substantially aligned rows in a matrix configuration.

26. The method of claim 13 wherein said top layer and said columns are integral.

27. The method of claim 13 wherein said columns are substantially perpendicular to said top and bottom surfaces.

28. The method of claim 13 wherein step (C) adheres said top layer to said top surface and said columns to said receptacles.

29. A method for producing a foam composite support pad having a top gel layer and gel columns within the foam composite support pad, the method comprising the steps of:
(A) providing a foam base portion comprising a top surface, an opposing bottom surface substantially parallel to said top surface, and a plurality of receptacles extending from said top surface towards said bottom surface;
(B) heating a gel composition to a liquid state;
(C) applying said liquid gel composition to said foam base portion such that said liquid gel composition flows into said plurality of receptacles; and
(D) cooling said liquid gel composition thereby forming said gel columns of said gel composition in said plurality of receptacles of said base portion and forming said top gel layer adjacent said top surface.

30. The method of claim 29 wherein said foam base portion comprises polyurethane, viscoelastic, or latex foam.

31. The method of claim 29 wherein said foam base portion comprises a plurality of layers of foam materials.

32. The method of claim 29 wherein said gel composition comprises an elastomeric non-soy gel.

33. The method of claim 29 wherein said top gel layer substantially covers said top surface.

34. The method of claim 29 wherein said plurality of receptacles are substantially round.

35. The method of claim 29 wherein said plurality of receptacles are arranged in substantially aligned rows in a matrix configuration.

36. The method of claim 29 wherein said top gel layer and said gel columns are integral.

37. The method of claim 29 wherein said gel columns are substantially perpendicular to said top and bottom surfaces.

38. The method of claim 29 wherein step (D) adheres said top layer to said top surface and said columns to said receptacles.
